(19) United States
(12) Patent Application Publication
(10) Pub. No.: US 2012/0301598 A1
(43) Pub. Date: Nov. 29, 2012

(54) COMPOSITION OF FEED PELLET AND METHODS FOR PRODUCTION

(75) Inventors: Kip Kevin Karges, Chester, SD (US); Francis M. Swain, Tea, SD (US)

(73) Assignee: POET RESEARCH, INC., Sioux Falls, SD (US)

(21) Appl. No.: 13/482,710

(22) Filed: May 29, 2012

Related U.S. Application Data
(60) Provisional application No. 61/490,229, filed on May 26, 2011.

(51) Int. Cl. A23K 1/06; A23P 1/12

(52) U.S. Cl. 426/624

(57) ABSTRACT

A composition and production of feed pellets are provided. In some embodiments, biomass is milled to less than around ⅜ inch. Biomass may include corn cobs and corn stover in (substantially) equal proportions, or may include a minimum of about 20% corn cobs. The biomass, dried distiller's grains with solubles, distillers solubles, and binders are mixed. In some embodiments, the ratio of ingredients is, on a w/w dry matter basis,: about 30-50% milled biomass, about 45-65% dried distillers grains, less than about 6% distillers solubles, and about less than around 2.5% binder. Once mixed, the ingredients may be conditioned using steam and extruded through a die of between ¼ and 3.5 inches in size. The pellets are cooled. The final pellets include about 13-21% protein, about 4-9% fat, about 25-45% neutral detergent fiber, and about 5-20% moisture. Further, the pellets possess a pellet durability index of greater than around 94%.

### CROSS-REFERENCE

This application claims the benefit of U.S. Provisional Application Ser. No. 61/490,229 filed May 26, 2011, and entitled “COMPOSITION OF FEED PELLET AND METHODS FOR PRODUCTION”, the entirety of which is expressly incorporated herein by reference.

### FIELD

The subject disclosure relates to pelletized animal feed products and to systems and methods for generating pelletized animal feed products.

### BACKGROUND

The demand for pelletized feed is driven by weather patterns that cause traditional forage shortages both in winter snow conditions and summer drought conditions. However, there is limited availability in the market for feed pellets or cubes containing a near complete ration of energy, protein, nutrients, and roughage. Traditional feed of this type is generally made from alfalfa and offered in pellets or cubes as an economical way to transport and physically feed to livestock. Feed pelletizing is, as conventionally practiced, an extrusion type thermoplastic molding operation in which finely divided particles of a feed ration are formed into compact, easily handled pellets.

Dried Distiller's Grains with Solubles (DDGS) and Dried Distiller's Grains (DDG) are regarded as a good source of protein and energy but can be difficult to transport and physically feed to livestock. Challenges exist in achieving efficient weight limits on certain modes of transportation and DDGS/DDG is known to “brick-up”, which can make unloading a challenge. Attempts have been made to densify DDGS in the form of pellets but due to challenges related to DDGS composition, the attempts do not add value above using DDGS in loose form.

Producers using DDGS in loose form, with or without loose forms of corn stover/cob and other forages, also contend with various challenges. Waste is caused from livestock trampling DDGS. Additionally, animals tend to consume the most palatable feed, therefore the animals may selectively consume one feed over another when loosely provided. Further, loose feeds tend to physically separate according to size and density, which may be undesirable.

Utilizing corn stover/cobs as a loose feed is a well understood and practiced standard. There also exists documented research indicating variances in nutritional values within the dead corn plant. These variances may lead to inconsistent uptake of nutrients by livestock being fed loose stover/cob. Corn stover/cobs is not a complete feed in itself and is generally supplemented with other forms of protein and nutrients from such feeds as distillers grains, alfalfa, corn, or other cereal grains. Again, the problem of selective feeding can be apparent with these feeding programs. The loose and low density of corn stover and cobs combined with its specific and limited nutritional value can create high transportation costs and can limit its use.

A number of attempts have been made to resolve these feeding challenges. For example, Scott Landers (U.S. Patent Publication No. 20080290548), entitled “PELLET MILL DIE AND PELLETIZING PROCESS”, discusses pelleting 100% DDG material. The resulting composition does not provide a complete feed solution, the size possible to generate with 100% DDG is generally too small for range pellets, and no PDI (pellet durability index) is provided, which is likely due to the tendency of 100% DDG pellets to have low durability.

Additionally, U.S. Pat. No. 4,996,065, entitled “MOLASSES-FREE CHEMICALLY REACTIVE BINDER FOR ANIMAL FEED”, discusses a feed pellet composition with binders to replace molasses binders. In this patent, the use of corn cob, distillers grains and distillers solubles, are mentioned as examples for possible pellet ingredients. However, the resulting pellets obtained have a PDI of less than 90%, which may be too low for range feed purposes.

### SUMMARY

The subject disclosure relates to a formulation of an animal feed pellet, which yields an animal feed pellet composition. Such a formulation and resulting pellet can provide high quality nutritional needs to farms in an easily transported medium.

The disclosed aspects relate to a composition of feed pellets and methods for the production of the feed pellets. In some embodiments, biomass can be milled to less than about ⅜ inch in size. Biomass may include corn cobs and corn stover in equal or substantially equal proportions, or may include a minimum of around 20% corn cobs. Alternate biomass sources, such as alfalfa can also be utilized in some embodiments.

The biomass, dried distiller's grains with solubles, distillers solubles, and binders may be mixed together. In some embodiments, the ratio of ingredients can be as follows: about 30-50% milled biomass on a w/w dry matter basis, about 45-65% dried distillers grains on a w/w dry matter basis, less than around 6% distillers solubles on a w/w dry matter basis, and about less than about 2.5% binder on a w/w dry matter basis.

Once mixed, the ingredients may be conditioned using steam. In some embodiments, steam conditioning may include providing steam at approximately 175 pounds per square inch for about 30 seconds. After steam conditioning, the ingredients may be extruded through a die of between about ¼ inch and about 3.5 inches in size. The pellets are then cooled.

The binder used to make the pellets includes at least one of molasses, lignin sulfate, and sodium bentonite. The final pellets include about 13-21% protein, about 4-9% fat, about 25-45% neutral detergent fiber, and about 5-20% moisture. Further, the pellets possess a pellet durability index of greater than around 94%.

### DESCRIPTION OF THE DRAWINGS

In order that the disclosed aspects may be more clearly ascertained, some embodiments will now be described, by way of example, with reference to the accompanying drawings, in which:

FIG. 1A is a perspective view of a biorefinery comprising an ethanol production facility, in accordance with some embodiments;

FIG. 1B is a perspective view of a biorefinery comprising an ethanol production facility, in accordance with some embodiments;

FIGS. 2A and 2B are process flow diagrams illustrating examples of ethanol production processes from corn to ethanol, in accordance with some embodiments;

FIG. 3 is a process flow diagram illustrating the preparation of biomass, in accordance with some embodiments;

FIG. 4 is an example schematic block diagram illustrating a system for generating feed pellets according to some embodiments;

FIG. 5 is an example flow chart diagram illustrating a process for the generation of feed pellets, in accordance with some embodiments;

TABLE 1 lists the composition of the feed pellet on a dry matter basis according to exemplary and representative embodiments; and

TABLE 2 lists the feed pellet characteristics according to exemplary and representative embodiments.

### DESCRIPTION OF THE EMBODIMENTS

The disclosed aspects will now be described with reference to several embodiments thereof as illustrated in the accompanying drawings. In the following description, numerous specific details are set forth in order to provide a thorough understanding of various embodiments. It will be apparent, however, to one skilled in the art, that embodiments may be practiced without some or all of these specific details. In other instances, well known process steps and/or structures have not been described in detail in order to not unnecessarily obscure the disclosed aspects. The features and advantages of embodiments may be better understood with reference to the drawings and discussions that follow.

The various aspects relate to a composition of a feed pellet and methods for producing the feed pellet. The composition can meet nutritional and durability standards. Further, the composition and methods for production of the composition can provide enhanced nutritional delivery to farm animals, a reliable feed source for farm owners, and a more readily handled feed for distributors. In addition, the composition and the methods of its production can enable consistent nutritional quality regardless of local weather, can discourage selective eating by livestock, and can provide for ease of handling.

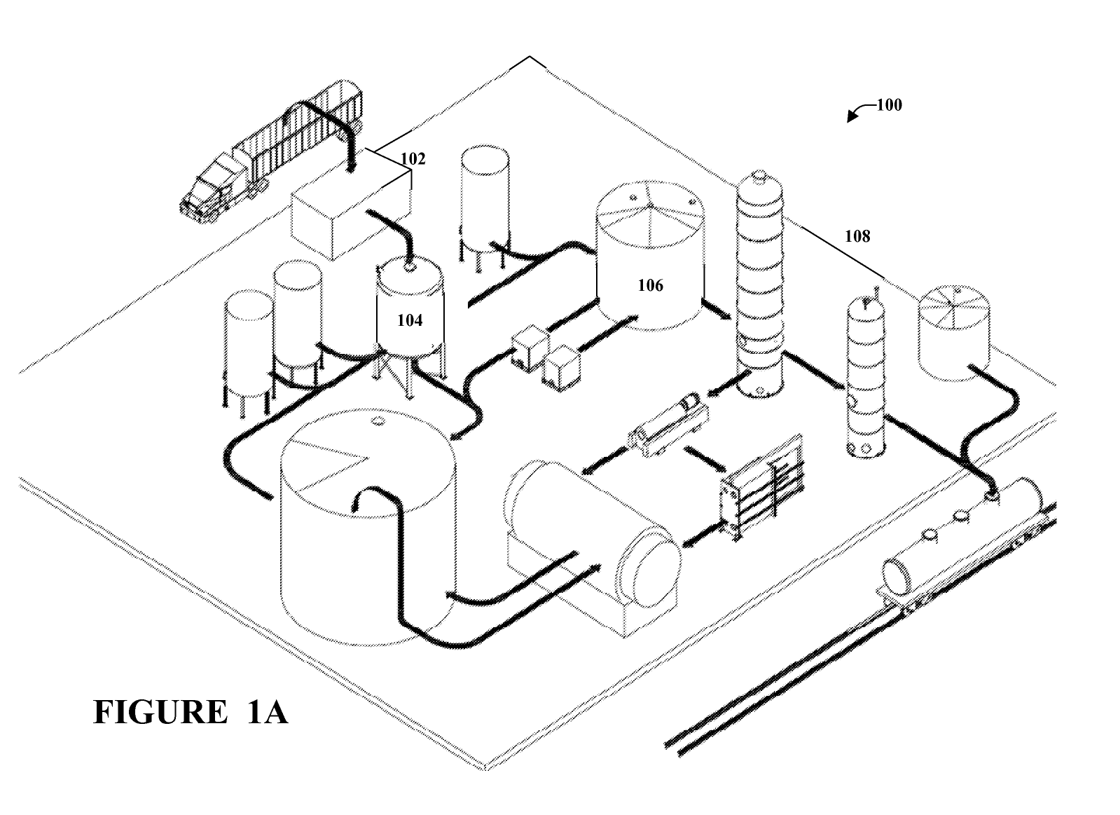

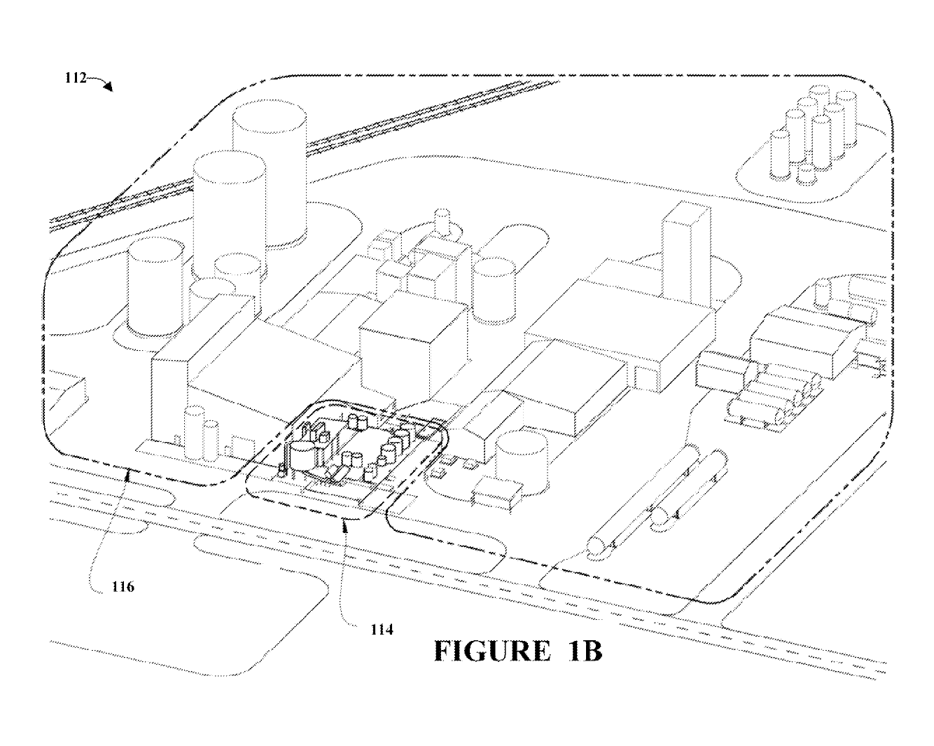

Referring to FIG. 1A, an example biorefinery 100 comprising an ethanol production facility configured to produce ethanol from corn is shown. The example biorefinery 100 comprises an area 102 where corn (or other suitable material including, but not limited to, biomass, sugars, and other starch products) can be delivered and prepared to be supplied to the ethanol production facility and co-located fiber production facility. The ethanol production facility can comprise an apparatus 104 for preparation and treatment (e.g., milling) of the corn into corn flour. Part of the milling process, in some embodiments, may also comprise separating the corn into three component materials: the fiber bran, endosperm, and germ. The flour may be suitable for fermentation into fermentation product in a fermentation system 106. The ethanol production facility can comprise a distillation system 108 in which the fermentation product can be distilled and dehydrated into ethanol. The biorefinery may also comprise, in some embodiments, a by-product treatment system (shown as comprising a centrifuge, a dryer, and an evaporator).

As shown in FIG. 1B, according to an exemplary embodiment, a biorefinery 112 may comprise a cellulosic ethanol production facility 114 (which produces ethanol from lignocellulosic material and components of the corn plant) co-located with a corn-based ethanol production facility 116 (which produces ethanol from starch contained in the endosperm component of the corn kernel). As indicated in FIG. 1B, by co-locating the two ethanol production facilities, certain plant systems may be shared, for example, systems for dehydration, storage, denaturing and transportation of ethanol, energy/fuel-to-energy generation systems, plant management and control systems, and other systems. Corn fiber (a component of the corn kernel), which can be made available when the corn kernel is prepared for milling (e.g. by fractionation) in the corn-based ethanol production facility, may be supplied to the cellulosic ethanol production facility as a feedstock. Fuel or energy sources such as methane or lignin from the cellulosic ethanol production facility may be used to supply power to either or both co-located facilities. According to other alternative embodiments, a biorefinery (e.g. a cellulosic ethanol production facility) may be co-located with other types of plants and facilities, for example an electric power plant, a waste treatment facility, a lumber mill, a paper plant, or a facility that processes agricultural products.

An advantage of co-locating a corn ethanol plant with the biomass ethanol plant is that, for the purposes of generating feed pellets, the infrastructure for two of the main ingredients, DDG and biomass, are present at the ethanol production facilities. The feed pellet production facility may be collocated with a biorefinery to capitalize on these efficiencies. Of course, it is within the scope of this disclosure that the ingredients utilized for the generation of feed pellets are generated at discrepant, remote locations and are shipped to the feed pellet processing location as needed.

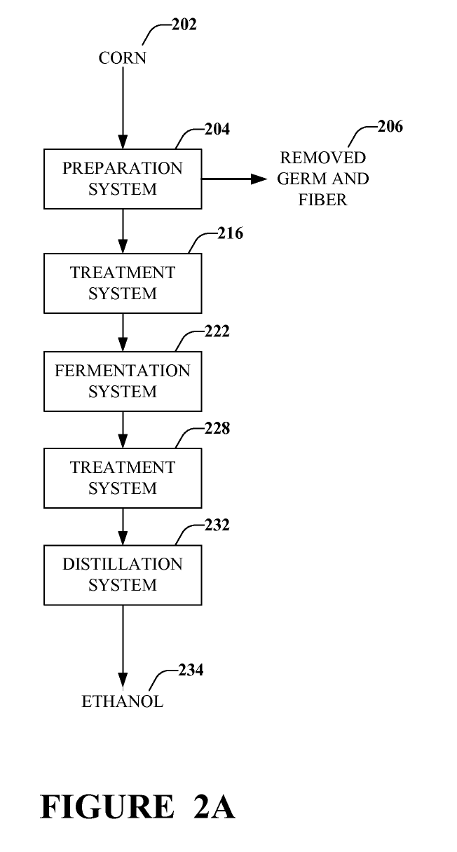

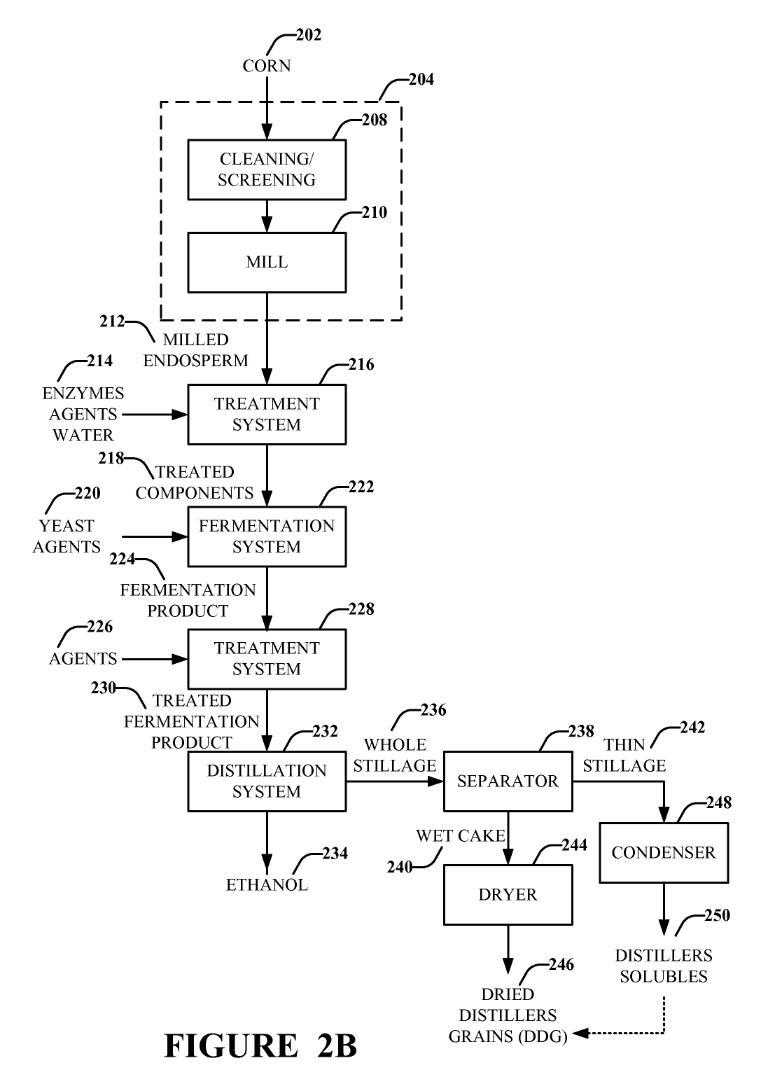

Referring to FIGS. 2A and 2B, in an ethanol production process, corn 202 (or other suitable feed material) may be prepared for further treatment in a preparation system 204, where components, such as germ and fiber 206 can be removed. As shown in FIG. 2B, the preparation system 204 may comprise cleaning or screening 208 to remove foreign material, such as rocks, dirt, sand, pieces of corn cobs and stalk, and other unfermentable material (e.g., removed components). After cleaning or screening 208, the corn may be reduced by milling 210 to facilitate further processing. In some cases, corn may be fractionated into component materials and the endosperm portion of the corn may be milled for fermentation purposes. The flour (or milled endosperm 212) can be slurried with water, enzymes and agents 214 to facilitate the conversion of starch into sugar (e.g. glucose), such as in a first treatment system 216. The sugar (e.g., treated component 218) can be converted into ethanol by an ethanologen (e.g. yeast or other agents 220) in a fermentation system 222. The product of fermentation (fermentation product 224) is beer, which comprises a liquid component, including ethanol and water and soluble components, and a solids component, including unfermented particulate matter (among other things). The fermentation product may be treated with agents 226 in a second treatment system 228. The treated fermentation product 230 can be sent to a distillation system 232. In the distillation system 232, the (treated) fermentation product can be distilled and dehydrated into ethanol 234. In some embodiments, the removed components (shown as, whole stillage 236), which comprise water, soluble components, oil, and unfermented solids (e.g., the solids component of the beer with substantially all ethanol removed), may be supplied to a seperator 238 to separate the wet cake solids 240 from the thin stillage liquid portion 242. The wet cake 240 may be dried in a dryer 244 to form Dried Distillers Grains (DDG) 246. The thin stillage 242 may be provided to a condenser 248 to concentrate the thin stillage to Distillers Solubles 250. Optionally, the solubles may be added back into the DDG to generate Dried Distillers Grains with Solubles (DDGS). Other co-products, for example, syrup (and oil contained in the syrup), may also be recovered from the stillage.

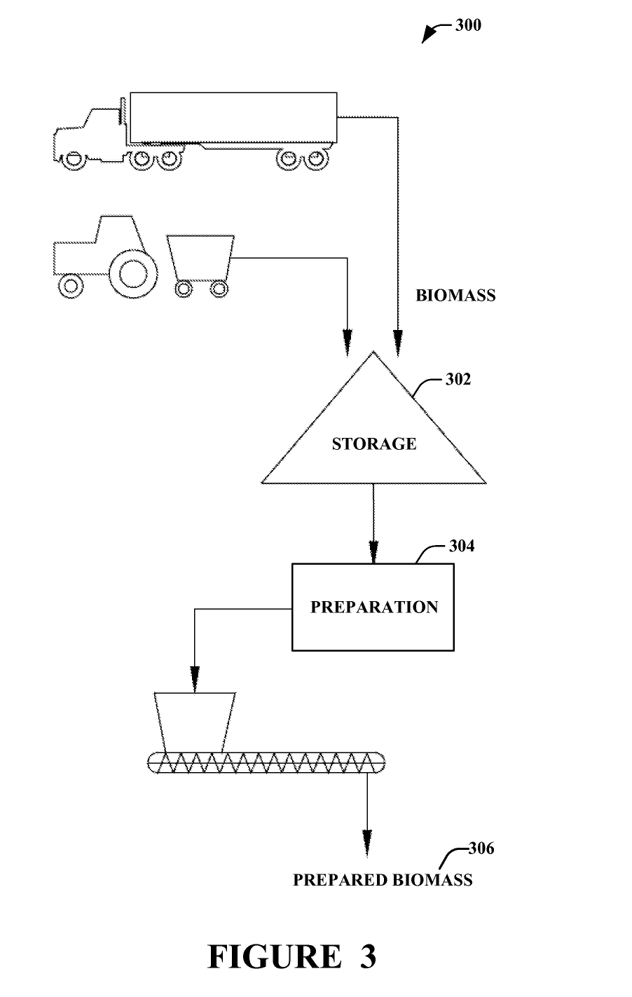

Referring to FIG. 3, a system 300 for preparation of biomass delivered to the biomass biorefinery is shown. The biomass preparation system may comprise apparatus for receipt/unloading of the biomass, cleaning (e.g. removal of foreign matter), grinding (e.g. milling, reduction or densification), and transport and conveyance for processing at the plant. According to an exemplary embodiment, biomass in the form of corn cobs and stover may be delivered to the biorefinery and stored 302 (e.g. in bales, piles or bins, etc.) and managed for use at the facility. According to an embodiment, the biomass may comprise at least about 20 to 30 percent corn cobs (by weight) with corn stover and other matter. According to other exemplary embodiments, the preparation system 304 of the biorefinery may be configured to prepare any of a wide variety of types of biomass 306 (e.g. plant material) for treatment and processing into ethanol and other bioproducts at the plant.

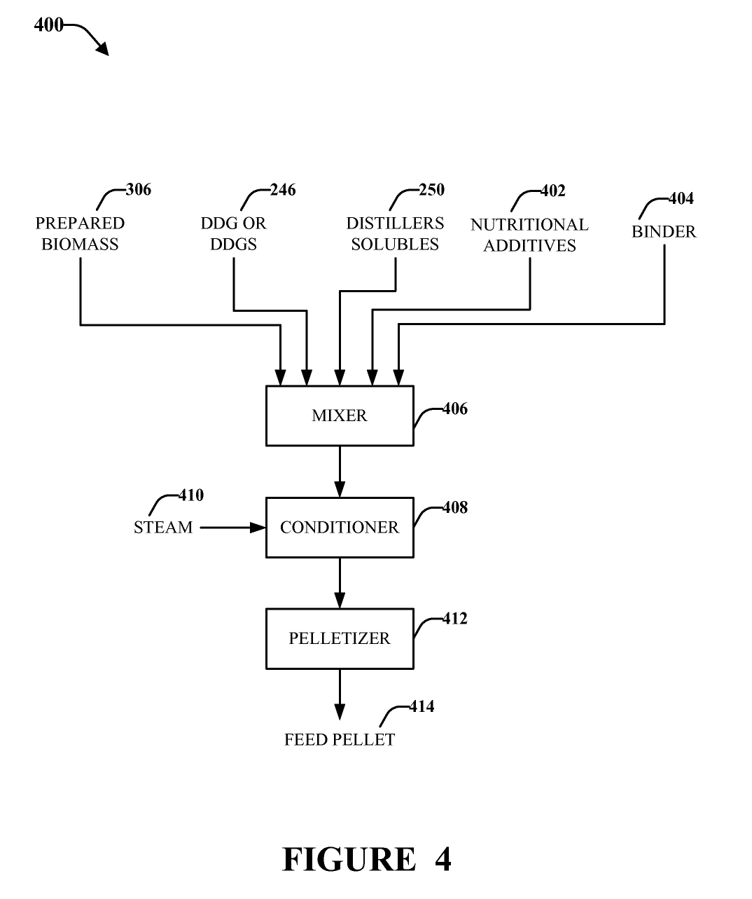

FIG. 4 is an example schematic block diagram illustrating a system for generating feed pellets, in accordance with some embodiments. In this diagram, prepared biomass 306, DDG and/or DDGS 246, distillers solubles 250 (optional), additional nutritional additives 402, and a binder 404 are added to a mixer 406 for combination and to ensure the pellets are sufficiently homogenous. The binder may include any of molasses, Lingo Tech (a lignin sulfate), sodium bentonite, or other suitable binding agent.

Additional nutritional additives 402 may mirror, or be substantially similar to, the guidelines presented in Nutrient Requirements of Beef Cattle, Seventh Revised Edition, 1996. In some embodiments, the nutritional additives may include the following nutrients: copper, iron, manganese, zinc, selenium, cobalt, iodine, Vitamin A, Vitamin D, and Vitamin E. The final pellets may, in some embodiments, provide between around 10-70% of the animal requirements for these nutrients dependent upon addition levels, animal intake, stage of production, and type of animal.

From the mixer 406 the homogenized pellet ingredients can be processed by a conditioning chamber 408 which may receive steam 410 and subject the pellet ingredients to elevated temperatures and moisture for a set period of time. In some embodiments conditioning may be anywhere from around 15 seconds to about 10 minutes but, in some particular embodiments, approximately a 30 second conditioning time can be sufficient. The moisture from the steam can increase lubrication, and partially gelatinize starches. The temperature of the ingredients may be raised to between about 120 and 230° F., dependent upon process conditions. In some embodiments, the lignin within the prepared biomass acts as a plasticizer as it is heated by steam conditioning. This effectively “glues” the pellet together and increases the final product's Pellet Durability Index (PDI). Further, in some embodiments syrup may be added to the ingredients to assist in lubrication of the ingredients through the pellet die.

The steam conditioned ingredients may be supplied to a pellitizer (i.e. pellet mill die chamber) 412 where the steamed ingredients are extruded through the die to generate the feed pellets 414. The hot extruded pellets are cooled, typically with forced air through vertical cooling systems.

An discussed herein, a feed pellet can be provided that includes about 30-50% biomass on a w/w dry matter basis, about 45-65% dried distillers grains on a w/w dry matter basis, less than about 6% distillers solubles on a w/w dry matter basis, and about less than 2.5% binder on a w/w dry matter basis.

In an implementation, the dried distillers grains include at least one of dried distillers grains with solubles, low fat dried distillers grains, and high protein dried distillers grains. In some implementations, the biomass includes corn cobs and corn stover. According to some implementations, the biomass includes a ratio of about 50% corn cobs and about 50% corn stover. In a further implementation, the biomass includes at least about 20% corn cobs, and the remainder can be corn stover. In some implementations, the binder includes at least one of molasses, lignin sulfate, and sodium bentonite.

In some implementations, the feed pellet includes about 13-21% protein, about 4-9% fat, about 25-45% neutral detergent fiber, and about 5-20% moisture. In another implementation, the feed pellet can comprise a pellet durability index of greater than 94%. In still another implementation, the feed pellet can comprise a densification improvement of greater than about 28% dried distillers grains with solubles and greater than about 100% corn stover.

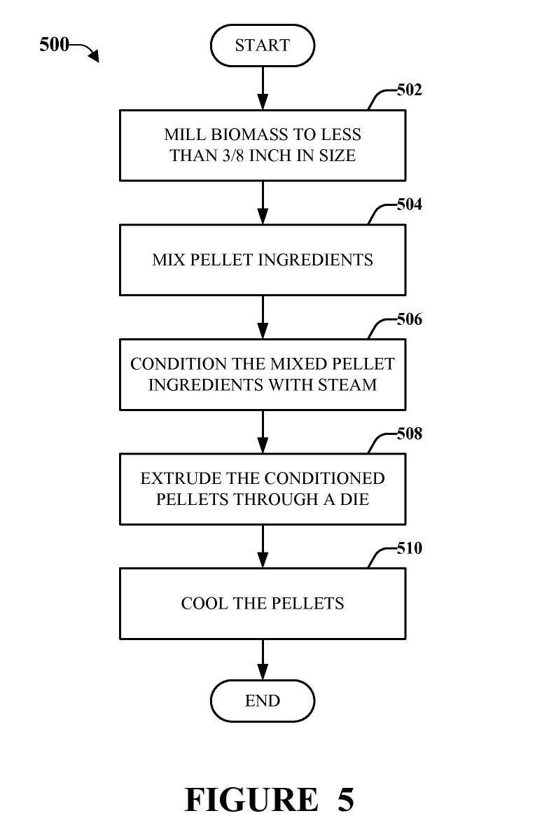

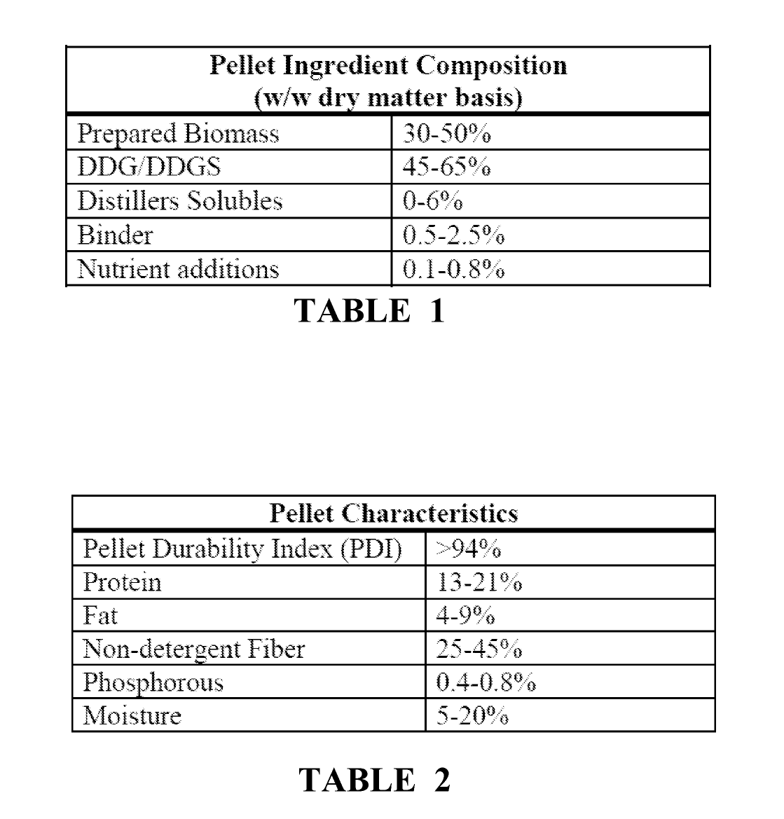

FIG. 5 is an example flow chart diagram 500 illustrating a process for the generation of feed pellets, according to an embodiment. In this process, biomass can be milled to less than ⅜ inch in size (at 502). Pellet ingredients can be mixed together (at 504). The pellet ingredients can include about 40% milled biomass on a w/w dry matter basis, about 55% dried distillers grains on a w/w dry matter basis, about 4.2% distillers solubles on a w/w dry matter basis, and about less than 1% binder on a w/w dry matter basis. In some implementations, the dried distillers grains can include at least one of dried distillers grains with solubles, low fat dried distillers grains, and high protein dried distillers grains. In some aspects, the biomass can include corn cobs and corn stover. In another implementation, the biomass can include a ratio of about 50% corn cobs and about 50% corn stover. In a further implementation, the biomass can include at least about 20% corn cobs, and the remainder can be corn stover. In another aspect, the binder includes at least one of molasses, lignin sulfate, and sodium bentonite.

The mixed pellet ingredients can be conditioned with steam (at 506). In an implementation, conditioning the mixed pellet ingredients can include supplying steam at about 175 pounds per square inch. In another implementation, conditioning the mixed pellet ingredients can include supplying steam for about 15 seconds.

The conditioned pellets can be extruded through a die (at 508) to generate pellets. The die can be between ¼ inch and 3.5 inches in size. The pellets can be cooled (at 510).According to some implementations, the pellets can comprise about 17% protein, about 6.8% fat, about 35% neutral detergent fiber, and about 12% moisture. In another implementation, the pellets can comprise a pellet durability index of greater than 94%.For suitable range feed pellets, a die of between ¼ inch and 3.5 inches may be particularly well suited. A pellet of less than ¼ of an inch may be lost through trampling. Pellets larger than 3.5 inches may be difficult for an animal to consume. Of course, alternate pellet sizes, and an array of pellet geometries, as can be dictated by the market, are considered within the scope of this disclosure.

A series of limited examples were conducted according to an exemplary embodiment of the system (as shown in FIG. 4) in an effort to determine suitable apparatus and operating conditions for the generation of feed pellets. The following examples are intended to provide clarity to some embodiments of systems and means of operation; given the limited nature of these examples, it does not limit the scope of the disclosed aspects.

### EXAMPLE

In the example production of feed pellets, the ingredients according to Table 1 were combined in a mixer to ensure homogeneity. The ingredients listed in Table 1 are provided in w/w percentage of dry matter basis. The majority of the material includes DDGS and prepared corn biomass. The corn biomass may include corn cobs and corn stover. In this example, the biomass included roughly 50% cob material, and the remaining material corn stover. The nutrient additions include mandated and market driven nutrition supplementation.

All of the ingredients are milled via a hammer mill to maximum of ⅜ inch particle size. After mixing, the ingredients are subjected to steam conditioning for 30 seconds. Steam is supplied at 175 psi in this example. Following conditioning, the conditioned ingredients are extruded through dies sized between ⅜ inch and 3.5 inches. Generally, per die between 500 and 600 pounds of pellets may be generated per hour. The pellets are cooled and subjected to testing for nutritional content and durability.

The results of the testing are provided in example Table 2. For the samples generated, the PDI was greater than 94%, which is significantly higher than previously known feed pellets. Additionally, the feed pellets included a favorable nutritional content with 13-21% protein, 4-9% fat, 25-45% neutral detergent fiber (non-detergent fiber or NDF), and 5-20% moisture. Further, the densification improvement of the pellets is 28% greater than DDGS and over 100% greater than stover

The embodiments as disclosed and described in the application (including the FIGURES and Examples) are intended to be illustrative and explanatory of the various aspects. Modifications and variations of the disclosed embodiments, for example, of the apparatus and processes employed (or to be employed) as well as of the compositions and treatments used (or to be used), are possible; all such modifications and variations are intended to be within the scope of the disclosed aspects.

The word “exemplary” is used to mean serving as an example, instance, or illustration. Any embodiment or design described as “exemplary” is not necessarily to be construed as preferred or advantageous over other embodiments or designs, nor is it meant to preclude equivalent exemplary structures and techniques known to those of ordinary skill in the art. Rather, use of the word exemplary is intended to present concepts in a concrete fashion, and the disclosed subject matter is not limited by such examples.

The term “or” is intended to mean an inclusive “or” rather than an exclusive “or.” To the extent that the terms “comprises,” “has,” “contains,” and other similar words are used in either the detailed description or the claims, for the avoidance of doubt, such terms are intended to be inclusive in a manner similar to the term “comprising” as an open transition word without precluding any additional or other elements.

What is claimed is:

1. A feed pellet, comprising:
about 30-50% biomass on a w/w dry matter basis;
about 45-65% dried distillers grains on a w/w dry matter basis;
less than about 6% distillers solubles on a w/w dry matter basis; and
less than about 2.5% binder on a w/w dry matter basis.

2. The feed pellet of claim 1, wherein the dried distillers grains comprise at least one of dried distillers grains with solubles, low fat dried distillers grains, and high protein dried distillers grains.

3. The feed pellet of claim 1, wherein the biomass comprises corn cobs and corn stover.

4. The feed pellet of claim 3, wherein the biomass comprises a ratio of about 50% corn cobs and about 50% corn stover.

5. The feed pellet of claim 3, wherein the biomass comprises at least about 20% corn cobs, and the remainder is corn stover.

6. The feed pellet of claim 1, wherein the binder comprises at least one of molasses, lignin sulfate, and sodium bentonite.

7. The feed pellet of claim 1, further comprising:
about 13-21% protein;
about 4-9% fat;
about 25-45% neutral detergent fiber; and
about 5-20% moisture.

8. The feed pellet of claim 1, further comprising a pellet durability index of greater than 94%.

9. The feed pellet of claim 1, further comprising a densification improvement of greater than about 28% dried distillers grains with solubles and greater than about 100% corn stover.

10. A method for generating a feed pellet, comprising:
milling biomass to less than ⅜ inch in size;
mixing pellet ingredients, wherein the pellet ingredients comprise about 40% milled biomass on a w/w dry matter basis, about 55% dried distillers grains on a w/w dry matter basis, about 4.2% distillers solubles on a w/w dry matter basis, and about less than 1% binder on a w/w dry matter basis;
conditioning the mixed pellet ingredients with steam;
extruding the conditioned pellet ingredients through a die to generate pellets, wherein the die is between ¼ inch and 3.5 inches in size; and
cooling the pellets.

11. The method of claim 10, wherein the dried distillers grains comprise at least one of dried distillers grains with solubles, low fat dried distillers grains, and high protein dried distillers grains.

12. The method of claim 10, wherein the biomass comprises corn cobs and corn stover.

13. The method of claim 12, wherein the biomass comprises a ratio of about 50% corn cobs and about 50% corn stover.

14. The method of claim 12, wherein the biomass comprises at least about 20% corn cobs, and the remainder is corn stover.

15. The method of claim 10, wherein the binder comprises at least one of molasses, lignin sulfate, and sodium bentonite.

16. The method of claim 10, wherein the pellets comprises about 17% protein, about 6.8% fat, about 35% neutral detergent fiber, and about 12% moisture.

17. The method of claim 10, wherein the pellets comprises a pellet durability index of greater than 94%.

18. The method of claim 10, wherein the conditioning the mixed pellet ingredients comprises supplying steam at about 175 pounds per square inch.

19. The method of claim 10, wherein the conditioning the mixed pellet ingredients comprises supplying steam for about 15 seconds.
